(19) United States
(12) Patent Application Publication
(10) Pub. No.: US 2024/0235645 A9
(43) Pub. Date: Jul. 11, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/404,912

(22) Filed: Jan. 5, 2024

Related U.S. Application Data
(63) Continuation of application No. PCT/CN2022/100955, filed on Jun. 24, 2022.

(30) Foreign Application Priority Data
Jul. 10, 2021 (CN) 202110780211.1

(51) Int. Cl. H04B 7/06; H04L 5/00

(52) U.S. Cl. CPC H04B 7/0658; H04B 7/0626; H04L 5/0051

(57) ABSTRACT

The present application provides a method and device in a node for wireless communications. A first node receives a first information block and a second information block, and transmits a third information block. The first information block indicates a first function; the second information block indicates whether a target reference signal resource is associated with the first function; the third information block indicates a first compressed CSI, and a first pre-compressed CSI is used as an input to the first function to generate the first compressed CSI. The above method can flexibly configure a relation between reference signals and AI algorithms/parameters, and select the optimal AI algorithm/parameter to compress/decompress a CSI based on a certain reference signal, thus optimizing the performance of CSI feedback.

### CROSS REFERENCE TO RELATED APPLICATIONS

This application is the continuation of the international patent application No. PCT/CN2022/100955, filed on Jun. 24, 2022, and claims the priority benefit of Chinese Patent Application CN202110780211.1, filed on Jul. 10, 2021, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

Multi-antenna technology is a key technology in both 3rd Generation Partner Project (3GPP) Long-term Evolution (LTE) system and New Radio (NR) system. Extra spatial degrees of freedom are acquired by configuring multiple antennas at a communication node, for instance, at a base station or a User Equipment (UE). Multiple antennas are used to improve the communication quality by forming a beam pointing in a specific direction through multi-antenna processing such as pre-coding and/or beamforming. In downlink multi-antenna transmission, a User Equipment (UE) usually needs to provide feedback on Channel State Information (CSI) to assist the base station in executing precoding and/or beamforming. With the increase of number of antennas, the cost of CSI feedback also increases. And various enhanced multi-antenna technologies, such as the application of multi-user MIMO, require higher feedback accuracy, thus further increasing the feedback overhead.

In 3GPP RAN #88e meeting and 3GPP R (release) 18 workshop, the application of Machine Learning (ML)/Artificial Intelligence (AI) in the physical layer of wireless communication systems has received widespread attention and discussion. The use of ML/AI to compressed CSI while addressing the accuracy and overhead of CSI feedback is widely considered one of the important applications of ML/AI at the physical layer.

### SUMMARY

In AI algorithms, the training process is very important, which directly affects the performance of AI algorithms. The applicant has found through researches that reference signals beamforming by different beams have different requirements for the AI training process. Compression of CSI obtained based on different reference signals with a same set of training-derived AI parameters yields different performance. How to adapt between the reference signal and the AI algorithms/parameters to optimize the CSI feedback performance is an issue that needs to be addressed.

To address the above problem, the present application provides a solution. It should be noted that although the above description takes the cellular network as an example, the application is also applicable to other scenarios, such as Vehicle-to-Everything (V2X) and sidelink transmission, where similar technical effects can be achieved. Besides, a unified solution for different scenarios (including but not limited to cellular networks V2X and sidelink transmission) can also help reduce hardware complexity and cost. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first information block, the first information block indicating a first function;

receiving a second information block, the second information block indicating whether a target reference signal resource is associated with the first function; and

transmitting a third information block, the third information block indicating a first compressed CSI, a first pre-compressed CSI being used as an input to the first function to generate the first compressed CSI.

In one embodiment, a problem to be solved in the present application comprises: how to adapt between reference signals and AI algorithms/parameters to optimize CSI feedback performance.

In one embodiment, characteristics of the above method comprise: the first function comprises an AI algorithm and a set of parameters obtained by training for use in the AI algorithm; the second information block indicates whether the CSI obtained against the target reference signal resource is compressed by the first function.

In one embodiment, advantages of the above method comprise: flexibly configuring a relation between reference signals and AI algorithms/parameters, selecting the optimal AI algorithm/parameter to compressed CSI based on a certain reference signal, optimizing the performance of CSI feedback.

According to one aspect of the present application, comprising:

transmitting a fourth information, the fourth information block indicating a second compressed CSI, a second pre-compressed CSI being used as an input to a first enhancement function to generate the second compressed CSI;

herein, the first function is used to generate the first enhancement function; the second information block indicates whether the target reference signal resource is associated with the first enhancement function.

In one embodiment, advantages of the above method comprise: adopting AI algorithms with different complexities to compress/decompressed CSI based on different reference signals better balances the complexity and performance of the algorithm/training.

According to one aspect of the present application, wherein the second information block indicates the first enhancement function.

According to one aspect of the present application, comprising:

transmitting a reference signal in a first reference signal resource pool, the first reference signal resource pool comprising at least one reference signal resource;

herein, a reception behavior in the first reference signal resource pool is used by a target receiver of the first reference signal resource pool to determine the first function.

According to one aspect of the present application, wherein the second information block comprises a first transmission configuration state, and the first transmission configuration state implicitly indicates whether the target reference signal resource is associated with the first function.

In one embodiment, advantages of the above method comprise: implicitly indicating a relation between reference signals and AI algorithms/parameters, thus reducing the signaling overhead.

According to one aspect of the present application, comprising:

transmitting a fifth information block, the fifth information indicating whether the target reference signal resource is suitable to be associated with the first function.

In one embodiment, advantages of the above method comprise: allowing the UE to adjust a corresponding between a reference signal indicated by the base station and the AI algorithm/parameter, further optimizes the match between the reference signal and the AI algorithm/parameter, thus optimizing the performance of the CSI feedback.

According to one aspect of the present application, wherein the first node is a UE.

According to one aspect of the present application, wherein the first node is a relay node.

The present application provides a method in a second node for wireless communications, comprising:

transmitting a first information block, the first information block indicating a first function;

transmitting a second information block, the second information block indicating whether a target reference signal resource is associated with the first function; and

receiving a third information block, the third information block indicating a first compressed CSI, a first pre-compressed CSI being used as an input to the first function to generate the first compressed CSI.

According to one aspect of the present application, comprising:

receiving a fourth information, the fourth information block indicating a second compressed CSI, a second pre-compressed CSI being used as an input to a first enhancement function to generate the second compressed CSI;

herein, the first function is used to generate the first enhancement function; the second information block indicates whether the target reference signal resource is associated with the first enhancement function.

According to one aspect of the present application, wherein the second information block indicates the first enhancement function.

According to one aspect of the present application, comprising:

receiving a reference signal in a first reference signal resource pool, the first reference signal resource pool comprising at least one reference signal resource;

herein, the reception behavior in the first reference signal resource pool is used by the second node to determine the first function.

According to one aspect of the present application, wherein the second information block comprises a first transmission configuration state, and the first transmission configuration state implicitly indicates whether the target reference signal resource is associated with the first function.

According to one aspect of the present application, comprising:

receiving a fifth information block, the fifth information indicating whether the target reference signal resource is suitable to be associated with the first function.

According to one aspect of the present application, wherein the second node is a base station.

According to one aspect of the present application, wherein the second node is a UE.

According to one aspect of the present application, wherein the second node is a relay node.

The present application provides a first node for wireless communications, comprising:

a first receiver, receiving a first information block and a second information block, the first information block indicating a first function, the second information block indicating whether a target reference signal resource is associated with the first function; and

a first transmitter, transmitting a third information block, the third information block indicating a first compressed CSI, a first pre-compressed CSI being used as an input to the first function to generate the first compressed CSI.

The present application provides a second node for wireless communications, comprising:

a second transmitter, transmitting a first information block and a second information block, the first information block indicating a first function, the second information block indicating whether a target reference signal resource is associated with the first function; and

a first receiver, receiving a third information block, the third information block indicating a first compressed CSI, a first pre-compressed CSI being used as an input to the first function to generate the first compressed CSI.

In one embodiment, the present application has the following advantages over conventional schemes:

flexibly configuring a relation between reference signals and AI algorithms/parameters, selecting the optimal AI algorithm/parameter to compress/decompressed CSI based on a certain reference signal, thus optimizing the performance of CSI feedback.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block, a second information block and a third information block according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless transmission according to one embodiment of the present application;

FIG. 6 illustrates a schematic diagram of a first function according to one embodiment of the present application;

FIG. 7 illustrates a schematic diagram of a second function according to one embodiment of the present application;

FIG. 8 illustrates a schematic diagram of relations among a first pre-compressed CSI, a first compressed CSI, a first function and a second function according to one embodiment of the present application;

FIG. 9 illustrates a schematic diagram of a relation between a second pre-compressed CSI and a second compressed CSI according to one embodiment of the present application;

FIG. 10 illustrates a schematic diagram of a first enhancement function according to one embodiment of the present application;

FIG. 11 illustrates a schematic diagram of a second enhancement function according to one embodiment of the present application;

FIG. 12 illustrates a schematic diagram of relations among a second pre-compressed CSI, a second compressed CSI, a first enhancement function and a second enhancement function according to one embodiment of the present application;

FIG. 13 illustrates a schematic diagram of a second information block indicating a first enhancement function according to one embodiment of the present application;

FIG. 14 illustrates a schematic diagram of a reception behavior in a first reference signal resource pool being used by a target receiver of the first reference signal resource pool to determine a first function according to one embodiment of the present application;

FIG. 15 illustrates a schematic diagram of a first transmission configuration state implicitly indicating whether a target reference signal resource is associated with a first function according to one embodiment of the present application;

FIG. 16 illustrates a schematic diagram of a fifth information block indicating whether a target reference signal resource is suitable to be associated with a first function according to one embodiment of the present application;

FIG. 17 illustrates a structure block diagram of a processor in a first node according to one embodiment of the present application;

FIG. 18 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first information block, a second information block and a third information block according to one embodiment of the present application, as shown in FIG. 1. In step 100 illustrated by FIG. 1, each box represents a step. And in particular, the order of steps in boxes does not represent a specific chronological order between the steps.

In Embodiment 1, the first node in the present application receives a first information block in step 101, and the first information block indicates a first function; receives a second information block in step 102, the second information block indicates whether a target reference signal resource is associated with the first function; transmits a third information block in step 103, the third information block indicates a first compressed CSI, and a first pre-compressed CSI is used as an input to the first function to generate the first compressed CSI.

In one embodiment, the first information block is carried by a higher-layer signaling.

In one embodiment, the first information block is carried by a Radio Resource Control (RRC) signaling.

In one embodiment, the first information block is carried by a Medium Access Control layer Control Element (MAC CE).

In one embodiment, the first information block is carried by a physical-layer signaling.

In one embodiment, the first information block comprises information in all or partial fields in an Information Element (IE).

In one embodiment, the first information block is carried by a L3 signaling.

In one embodiment, a channel occupied by the first information block comprises a Physical Downlink Shared CHannel (PDSCH).

In one embodiment, a channel occupied by the first information block comprises a Physical Downlink Control Channel (PDCCH).

In one embodiment, a channel occupied by the first information block comprises a Downlink Shared Channel (DL-SCH).

In one embodiment, the second information block is carried by a higher-layer signaling.

In one embodiment, the second information block is carried by an RRC signaling.

In one embodiment, the second information block is carried by a MAC CE.

In one embodiment, the second information block is carried by a physical-layer signaling.

In one embodiment, the second information block is carried by an RRC signaling and a MAC CE together.

In one embodiment, the second information block is carried by an RRC signaling and a physical-layer signaling together.

In one embodiment, the second information block is carried by an IE.

In one embodiment, a name of an IE carrying the second information block comprises “CSI-ReportConfig”.

In one embodiment, a name of an IE carrying the second information block comprises “CSI-ResourceConfig”.

In one embodiment, a name of an IE carrying the second information block comprises “CSI-MeasConfig”.

In one embodiment, a name of an IE carrying the second information block comprises “NZP-CSI-RS-Re source”.

In one embodiment, the second information block is earlier than the first information block in time domain.

In one embodiment, the second information block is later than the first information block in time domain.

In one embodiment, the first information block and the second information are carried by different fields in a same IE.

In one embodiment, the first information block and the second information block are carried by different IEs.

In one embodiment, the first information block and the second information block are carried by different signalings.

In one embodiment, the target reference signal resource comprises a Channel State Information-Reference Signal (CSI-RS) resource.

In one embodiment, the target reference signal resource is a CSI-RS resource.

In one embodiment, the target reference signal resource comprises Synchronisation Signal (SS)/physical broadcast channel (PBCH) Block resources.

In one embodiment, the target reference signal resources are CSI-RS resources or SS/PBCH Block resources.

In one embodiment, the target reference signal resource comprises Sounding Reference Signal (SRS) resources.

In one embodiment, the target reference signal resource comprises a Demodulation Reference Signal (DMRS) port.

In one embodiment, the target reference signal resource comprises a Phase Tracking Reference Signal (PTRS) port.

In one embodiment, the target reference signal resource comprises at least one RS port.

In one subembodiment of the above embodiment, the RS port comprises a CSI-RS port.

In one subembodiment of the above embodiment, the RS port comprises an antenna port.

In one subembodiment of the above embodiment, the RS port comprises at least one of a DMRS port, a PTRS port, or an SRS port.

In one embodiment, the target reference signal resource is aperiodic.

In one embodiment, the target reference signal resource is quasi-static.

In one embodiment, the target reference signal resource is periodic.

In one embodiment, an occurrence of the target reference signal resource in time domain is earlier than the second information block.

In one embodiment, an occurrence of the target reference signal resource in time domain is later than the second information block.

In one embodiment, the second information block indicates the target reference signal resource.

In one embodiment, the second information block indicates configuration information of the target reference signal resource.

In one embodiment, the configuration information of the target reference signal resource comprises all or part of time-domain resources, frequency-domain resources, Code Division Multiplexing (CDM) type (cdm type), CDM group, scrambling, period, slot offset, Quasi Co-Location (QCL) relation, density, or number of RS port(s).

In one embodiment, the second information block indicates an identifier of the target reference signal resource.

In one embodiment, an identifier of the target reference signal resource comprises NZP-CSI-RS-ResourceId or SSB-Index.

In one embodiment, the second information block indicates that the target reference signal resource is associated with the first function.

In one embodiment, the second information block indicates that the target reference signal resource is not associated with the first function.

In one embodiment, the second information block indicates that a measurement for a reference signal received in the target reference signal resource is not suitable for generating a compressed CSI.

In one embodiment, the second information block indicates that a measurement for a reference signal received in the target reference signal resource is not used for generating a compressed CSI.

In one embodiment, the second information block indicates that the first node does not obtain channel measurement for generating a compressed CSI based on a reference signal received in the target reference signal resource.

In one embodiment, the second information block explicitly indicates whether the target reference signal resource is associated with the first function.

In one embodiment, the second information block comprises a first bit field, and the first bit filed comprises at least one bit; a value of the first bit field indicates whether the target reference signal resource is associated with the first function.

In one embodiment, the second information block implicitly indicates whether the target reference signal resource is associated with the first function.

In one embodiment, the configuration information of the target reference signal resource implicitly indicates whether the target reference signal resource is associated with the first function.

In one embodiment, time-frequency resources occupied by the target reference signal resource are used to determine whether the target reference signal resource is associated with the first function.

In one embodiment, at least one of CDM type or CDM group of the target reference signal resource is used to determine whether the target reference signal resource is associated with the first function.

In one embodiment, a QCL relation of the target reference signal resource are used to determine whether the target reference signal resource is associated with the first function.

In one embodiment, a number of RS port(s) of the target reference signal resource are used to determine whether the target reference signal resource is associated with the first function.

In one embodiment, the first function is one of M1 functions, where M1 is a positive integer greater than 1; the second information block indicates whether the target reference signal resource is associated with one of the M1 functions; when the second information block indicates that the target reference signal resource is associated with one of the M1 functions, the second information block indicates which function of the M1 functions the target reference signal resource is associated with.

In one subembodiment of the above embodiment, the M1 functions are respectively non-linear.

In one subembodiment of the above embodiment, any of the M1 functions comprises an encoder used for a neural network used for CSI compression.

In one subembodiment of the above embodiment, at least one of convolution kernel, convolution kernel size, number of convolution layers, convolution step-size, pooling function, pool kernel size, pool kernel step-size, parameters of pooling function, activation function, threshold of activation function, number of feature maps, or weight between feature maps comprised in any two different functions in the M1 functions is different.

In one embodiment, when the second information block indicates that the target reference signal resource is associated with the first function, the second information block also indicates which RS ports of the target reference signal resource are associated with the first function.

In one embodiment, when the target reference signal resource is associated with the first function, all RS ports of the target reference signal resource are associated with the first function.

In one embodiment, when the target reference signal resource is associated with the first function, all RS ports only partial RS ports of the target reference signal resource are associated with the first function.

In one embodiment, the meaning of the phrase of the target reference signal resource being associated with the first function comprises: a measurement for a reference signal received in the target reference signal resource is used as an input to the first function.

In one embodiment, the meaning of the phrase of the target reference signal resource being associated with the first function comprises: a measurement for a reference signal received in the target reference signal resource is used to generate an input to the first function.

In one embodiment, the meaning of the phrase of the target reference signal resource being associated with the first function comprises: a CSI obtained by a channel measurement based on a reference signal received in the target reference signal resource is used as an input to the first function.

In one subembodiment of the above embodiment, the CSI comprises an uncompressed CSI.

In one embodiment, the meaning of the phrase of the target reference signal resource being associated with the first function comprises: the first node obtains a channel measurement used to calculate an input to the first function based on a reference signal received in the target reference signal resource.

In one embodiment, the meaning of the phrase of the target reference signal resource being associated with the first function comprises: the first function is used to compressed CSI obtained based on a channel measurement for a reference signal received in the target reference signal resource.

In one embodiment, the meaning of the phrase of the target reference signal resource being associated with the first function comprises: the first function is used to compress information of a channel over which a reference signal received in the target reference signal resource is conveyed.

In one embodiment, the meaning of the phrase of the target reference signal resource being associated with the first function comprises: a measurement for a reference signal received in the target reference signal resource is not used to generate an input to the first function.

In one embodiment, the meaning of the phrase of the target reference signal resource not being associated with the first function comprises: a CSI obtained based on a channel measurement for a reference signal received in the target reference signal resource is not used as an input to the first function.

In one subembodiment of the above embodiment, the CSI comprises an uncompressed CSI.

In one embodiment, the meaning of the phrase of the target reference signal resource not being associated with the first function comprises: the first node obtains a channel measurement used to calculate an input to the first function not based on a reference signal received in the target reference signal resource.

In one embodiment, the meaning of the phrase of the target reference signal resource not being associated with the first function comprises: the first function is not used to compressed CSI obtained based on a channel measurement for a reference signal received in the target reference signal resource.

In one embodiment, the meaning of the phrase of the target reference signal resource not being associated with the first function comprises: the first function is not used to compress information of a channel over which a reference signal received in the target reference signal resource is conveyed.

In one embodiment, if the target reference signal resource is not associated with the first function, and a measurement for a reference signal received in the target reference signal resource is not used to generate the first pre-compressed CSI.

In one embodiment, if the target reference signal resource is not associated with the first function, the first node obtains a channel measurement used to calculate the first pre-compressed CSI not based on a reference signal received in the target reference signal resource.

In one embodiment, if only partial RS ports in the target reference signal resource are associated with the first function, the first node obtains a channel measurement used to obtain an input to the first function only based on a reference signal received on the partial RS ports.

In one embodiment, if only partial RS ports in the target reference signal resource are associated with the first function, the first function is only used to compress information of a channel over which a reference signal received on the partial RS ports is conveyed.

In one embodiment, the third information block is carried by a physical layer signaling.

In one embodiment, the third information block is carried by a MAC CE signaling.

In one embodiment, the third information block comprises Uplink Control Information (UCI).

In one embodiment, the third information block comprises Channel State Information (CSI).

In one embodiment, the CSI refers to Channel State Information.

In one embodiment, the CSI comprises a channel matrix.

In one embodiment, the CSI comprises information of a channel matrix.

In one embodiment, the CSI comprises amplitude and phase information of elements in a channel matrix.

In one embodiment, the third information block comprises the first compressed CSI.

In one embodiment, the second information block indicates that the target reference signal resource is associated with the first function, and a measurement for a reference signal received in the target reference signal resource is used to generate the first pre-compressed CSI.

In one embodiment, the second information block indicates that the target reference signal resource is associated with the first function, and the first node obtains a channel measurement used to generate the first pre-compressed CSI based on a reference signal received in the target reference signal resource.

In one embodiment, the first pre-compressed CSI is unrelated to a measurement for a reference signal received in the target reference signal resource.

In one embodiment, the second information block indicates that the target reference signal resource is not associated with the first function, and the first pre-compressed CSI is unrelated to a measurement for a reference signal received in the target reference signal resource.

In one embodiment, the first pre-compressed CSI is used by the first node as an input to the first function to generate the first compressed CSI.

In one embodiment, the first pre-compressed CSI comprises a Precoding Matrix Indicator (PMI).

In one embodiment, the first pre-compressed CSI comprises one or more of a Channel Quality Indicator (CQI), a CSI-RS Resource Indicator (CRI) or a Rank Indicator (RI).

In one embodiment, the first pre-compressed CSI comprises a channel matrix.

In one embodiment, the first pre-compressed CSI comprises amplitude and phase information of elements in a channel matrix.

In one embodiment, the first pre-compressed CSI comprises information of a channel matrix.

In one embodiment, the first compressed CSI comprises a PMI.

In one embodiment, the first compressed CSI comprises one or multiple of a CQI, a CRI or an RI.

In one embodiment, the first compressed CSI comprises a matrix.

In one embodiment, the first compressed CSI comprises a vector.

In one embodiment, the first compressed CSI comprises information of a channel matrix.

In one embodiment, the first compressed CSI comprises amplitude and phase information of elements in a channel matrix.

In one embodiment, the first pre-compressed CSI comprises a first matrix, the first compressed CSI comprises a second matrix, and a product of row number and column number of the second matrix is less than a product of row number and column number of the first matrix.

In one subembodiment of the above embodiment, the second matrix is a vector.

In one embodiment, the first pre-compressed CSI consists of Q1 bits, the first compressed CSI consists of Q2 bits, Q1 and Q2 respectively being positive integers greater than 1, Q1 being greater than the Q2.

In one embodiment, the first function is non-linear.

In one embodiment, an input to the first function comprises CSI.

In one embodiment, an input to the first function comprises a result of a channel measurement.

In one embodiment, an input to the first function comprises channel matrix.

In one embodiment, an input to the first function comprises an uncompressed CSI.

In one embodiment, an output of the first function comprises a compressed CSI.

In one embodiment, a payload of any input of the first function is greater than a payload of an output of the any input corresponding to the first function.

In one embodiment, a number of element(s) comprised in any input of the first function is greater than a number of element(s) comprised in an output of the any input corresponding to the first function.

In one embodiment, the first function comprises a Neural Network.

In one embodiment, the first function comprises a neural network used for CSI compression.

In one embodiment, the first function comprises an encoder of a neural network used for CSI compression.

### Embodiment 2

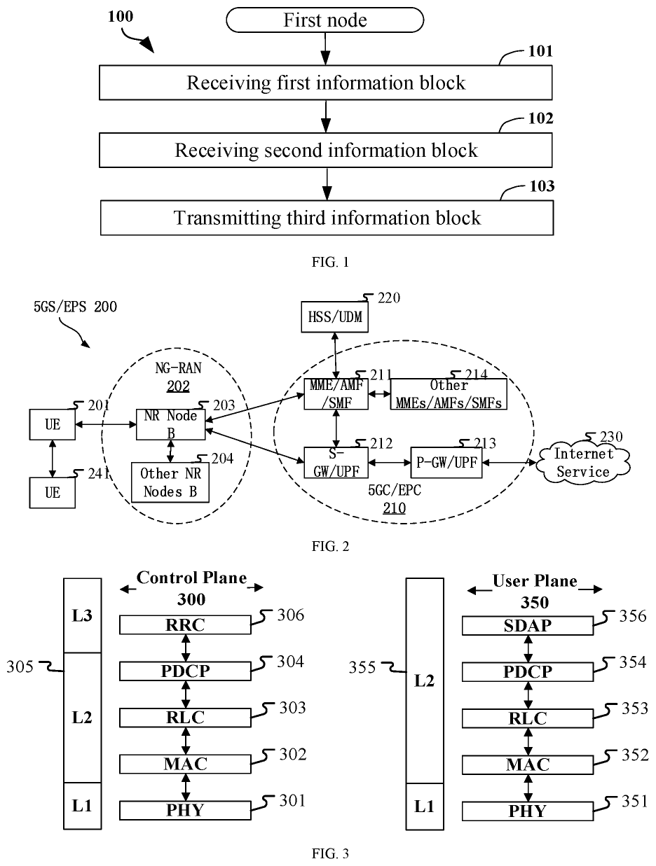

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 is a cellular network link.

In one embodiment, a transmitter of the first information block comprises the gNB 203.

In one embodiment, a receiver of the first information block comprises the UE 201.

In one embodiment, a transmitter of the second information block comprises the gNB 203.

In one embodiment, a receiver of the second information block comprises the UE 201.

In one embodiment, a transmitter of the third information block comprises the UE 201.

In one embodiment, a receiver of the third information block comprises the gNB 203.

In one embodiment, the UE201 supports CSI compression based on Convolutional Neural Networks (CNN).

### Embodiment 3

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block is generated by the MAC sublayer 302 or the MAC sublayer 352.

In one embodiment, the first information block is generated by the RRC sublayer 306.

In one embodiment, the second information block is generated by the MAC sublayer 302 or the MAC sublayer 352.

In one embodiment, the second information block is generated by the RRC sublayer 306.

In one embodiment, the third information block is generated by the PHY 301 or the PHY 351.

### Embodiment 4

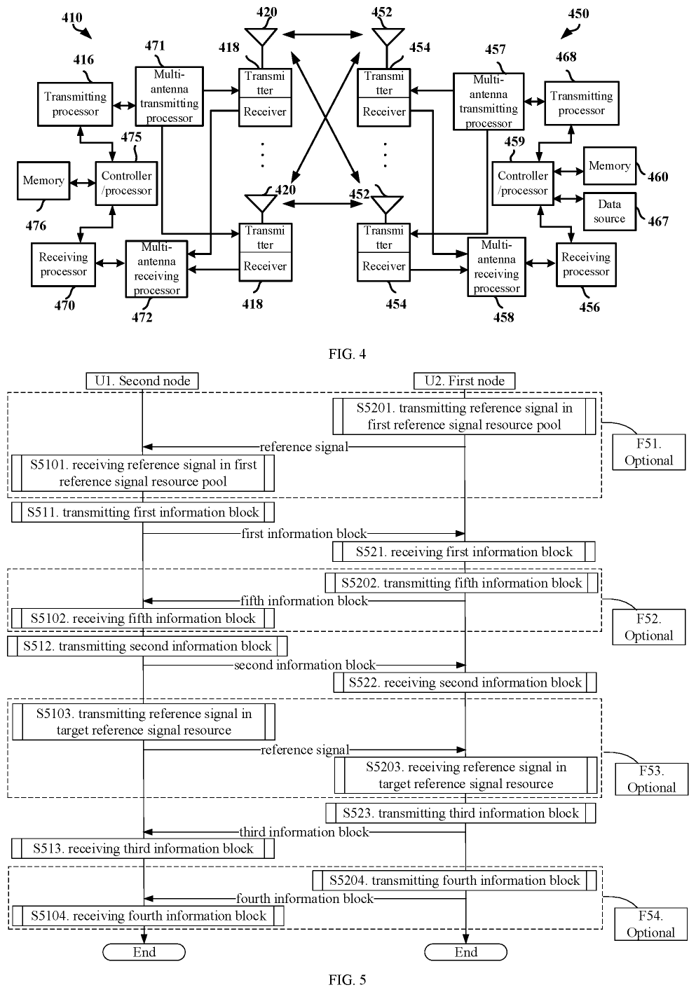

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first information block; receives the second information block; and transmits the third information block.

In one embodiment, the second communication device 450 comprises a memory that stores a computer readable instruction program. The computer readable instruction program generates an action when executed by at least one processor. The action includes: receiving the first information block; receiving the second information block; and transmitting the third information block.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first information block; transmits the second information block; and receives the third information block.

In one embodiment, the first communication device 410 comprises a memory that stores a computer readable instruction program. The computer readable instruction program generates an action when executed by at least one processor. The action includes: transmitting the first information block; transmitting the second information block; and receiving the third information block.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first information block in the present application; at least one of the antenna 420, the transmitter 418, the transmitting processor 416, the multi-antenna transmitting processor 471, the controller/processor 475, or the memory 476 is used to transmit the first information block.

In one embodiment, at least one of the antenna 452, the receiver 454, the receiving processor 456, the multi-antenna receiving processor 458, the controller/processor 459, the memory 460, or the data source 467 is used to receive the second information block in the present application; at least one of the antenna 420, the transmitter 418, the transmitting processor 416, the multi-antenna transmitting processor 471, the controller/processor 475, or the memory 476 is used to transmit the second information block.

In one embodiment, at least one of the antenna 420, the receiver 418, the receiving processor 470, the multi-antenna receiving processor 472, the controller/processor 475 or the memory 476 is used to receive the third information block; at least one of the antenna 452, the transmitter 454, the transmitting processor 468, the multi-antenna transmitting processor 457, the controller/processor 459, the memory 460, or the data source 467 is used to transmit the third information block.

In one embodiment, at least one of the antenna 420, the receiver 418, the receiving processor 470, the multi-antenna receiving processor 472, the controller/processor 475 or the memory 476 is used to receive the fourth information block; at least one of the antenna 452, the transmitter 454, the transmitting processor 468, the multi-antenna transmitting processor 457, the controller/processor 459, the memory 460, or the data source 467 is used to transmit the fourth information block.

In one embodiment, at least one of the antenna 420, the receiver 418, the receiving processor 470, the multi-antenna receiving processor 472, the controller/processor 475, or the memory 476 is used to receive a reference signal in the first reference signal resource pool; at least one of the antenna 452, the transmitter 454, the transmitting processor 468, the multi-antenna transmitting processor 457, the controller/processor 459, the memory 460, or the data source 467 is used to transmit a reference signal in the first reference signal resource pool.

In one embodiment, at least one of the antenna 420, the receiver 418, the receiving processor 470, the multi-antenna receiving processor 472, the controller/processor 475 or the memory 476 is used to receive the fifth information block; at least one of the antenna 452, the transmitter 454, the transmitting processor 468, the multi-antenna transmitting processor 457, the controller/processor 459 or the memory 460 is used to transmit the fifth information block.

### Embodiment 5

Embodiment 5 illustrates a flowchart of wireless transmission according to one embodiment in the present application, as shown in FIG. 5. In FIG. 5, a second node U1 and a first node U2 are communication nodes transmitted via an air interface. In FIG. 5, steps in F51 and F54 are respectively optional.

The second node U1 receives a reference signal in a first reference signal resource pool in step S5101; transmits a first information block in step S511; receives a fifth information block in step S5102; transmits a second information block in step S512; transmits a reference signal in a target reference signal resource in step S5103; receives a third information block in step S513; receives a fourth information block in step S5104.

The first node U2 receives a reference signal in a first reference signal resource pool in step S5201; receives a first information block in step S521; transmits a fifth information block in step S5202; receives a second information block in step S522; receives a reference signal in a target reference signal resource in step S5203; transmits a third information block in step S523; transmits a fourth information block in step S5204.

In Embodiment 5, the first information block indicates a first function; the second information block indicates whether the target reference signal resource is associated with the first function; the third information block indicates a first compressed CSI, a first pre-compressed CSI is used by the first node U2 as an input to the first function to generate the first compressed CSI.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the first information block is transmitted in a PDSCH.

In one embodiment, the second information block is transmitted in a PD SCH.

In one embodiment, the third information block is transmitted in a Physical Uplink Shared CHannel (PUSCH).

In one embodiment, the third information is transmitted in a Physical Uplink Control Channel (PUCCH).

In one embodiment, steps in box F51 in FIG. 5 exist; the first reference signal resource pool comprises at least one reference signal resource; herein, a reception behavior in the first reference signal resource pool is used by the second node U1 to determine the first function.

In one embodiment, steps in the box F52 in FIG. 5 exist; the fifth information block indicates whether the target reference signal resource is suitable to be associated with the first function.

In one embodiment, the fifth information block is transmitted in a PUSCH.

In one embodiment, the fifth information block is transmitted in a PUCCH.

In one embodiment, steps in box F53 in FIG. 5 exist; the method in a first node used for wireless communications comprises: receiving a reference signal in the target reference signal resource.

In one embodiment, steps in box F53 in FIG. 5 exist; the method in a second node for wireless communications comprises: transmitting a reference signal in the target reference signal resource.

In one embodiment, the meaning of the phrase of receiving a reference signal in the target reference signal resource comprises: receiving a transmitted reference signal according to configuration information of the target reference signal resource.

In one embodiment, steps in box F54 in FIG. 5 exist; the fourth information block indicates a second compressed CSI, and a second pre-compressed CSI is used as an input to a first enhancement function to generate the second compressed CSI; herein, the first function is used by the first node U2 to generate the first enhancement function; the second information block indicates whether the target reference signal resource is associated with the first enhancement function.

In one embodiment, the fourth information block is carried by a physical-layer signaling.

In one embodiment, the fourth information block comprises a UCI.

In one embodiment, the fourth information block comprises a CSI.

In one embodiment, the fourth information block is earlier than the third information block.

In one embodiment, the fourth information block is later than the third information block.

In one embodiment, the fourth information block comprises the second compressed CSI.

In one embodiment, the fourth information block is transmitted in a PUSCH.

In one embodiment, the fourth information block is transmitted in a PUCCH.

### Embodiment 6

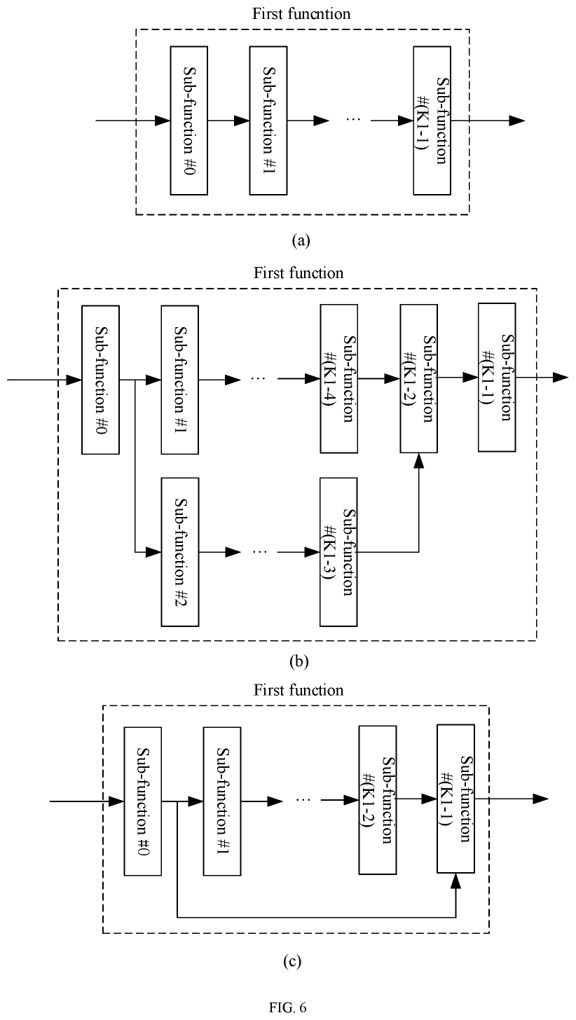

Embodiment 6 illustrates a schematic diagram of a first function according to one embodiment of the present application, as shown in FIG. 6. In embodiment 6, the first function comprises K1 sub-functions, K1 being a positive integer greater than 1. In FIG. 6, the K1 sub-functions are respectively represented by sub-function #0, . . . , sub-function #(k1−1).

In one embodiment, the first function comprises a first parameter group, and the first parameter group comprises at least one parameter.

In one embodiment, the first parameter group comprises one or multiple of a convolution kernel, pooling function, parameters of pooling function, activation function, a threshold of activation function, weights between feature maps.

In one embodiment, the K1 sub-functions comprise one or more of convolutional function, pooling function, cascading function, or activation function.

In one embodiment, the first parameter group comprises K1 parameter sub-groups, and the K1 parameter sub-groups are respectively used for the K1 sub-functions.

In one embodiment, the first information indicates a value of a parameter in the first parameter group.

In one embodiment, the first information block indicates features of the first function.

In one embodiment, the first information block indicates partial features of the first function.

In one embodiment, the first information block indicates all features of the first function.

In one embodiment, the first information indicates a value of a parameter in the first parameter group and the features of the first function.

In one embodiment, the features of the first function comprise: one or more of the convolution kernel size, convolution layer, convolution step-size, pooling kernel size, pooling function, activation function, or number of feature maps.

In one embodiment, there exists one of the K1 sub-function(s) comprising fully-connected layer.

In one subembodiment of the above embodiment, the sub-function #(K1-1) in FIG. 6 comprises a fully-connected layer.

In one embodiment, there exists one of the K1 sub-functions comprising a pooling layer.

In one embodiment, there exists at least one of the K1 sub-function(s) comprising at least one convolutional layer.

In one embodiment, there exists at least one of the K1 sub-function(s) comprising at least one encoding layer.

In one embodiment, there exists one of the K1 sub-function(s) comprising a fully-connected layer, and there exists at least another one of the K1 sub-function(s) comprising at least one encoding layer.

In one embodiment, an encoding layer comprises at least one convolutional layer.

In one embodiment, an encoding layer comprise at least one convolutional layer and one pooling layer.

In one embodiment, at the convolutional layer, at least one convolution kernel is used to convolve an input to the first function to generate a corresponding feature map, and the at least one feature map output from the convolutional layer is reshaped into a vector to be input to the fully-connected layer; the fully-connected layer converts the vector into an output of the first function.

In one embodiment, the first parameter set comprises at least one of a convolution kernel of any of the K1 sub-functions, or weights between different convolutional layers in the K1 sub-functions.

In one embodiment, there exist two of the K1 sub-functions being cascaded, that is, an input of one of the two sub-functions is an input of the other one of the two sub-functions.

In one subembodiment of the above embodiment, sub-function #0 and sub-function #1 in FIG. 6(a) and FIG. 6(b) are cascaded.

In one embodiment, there exist two sub-functions among the K1 sub-functions being parallel; that is, an output of the two sub-functions are jointly used as an input to another one of the K1 sub-functions, or an output of another one of the K1 sub-functions is simultaneously used as an input to the two sub-functions.

In one subembodiment of the above embodiment, sub-function #1 and sub-function #2 in FIG. 6(b) are parallel.

In one subembodiment of the above embodiment, sub-function #(K1-3) and sub-function #(K1-4) in FIG. 6(b) are parallel.

In one embodiment, the features of the first function comprise: at least one of a value of K1, a number of sub-functions comprising the convolutional layer in the K1 sub-functions, a size of input parameters and a size of output parameters for each convolutional layer, or a relation between the K1 sub-functions.

In one subembodiment of the above embodiment, the relation between the K1 sub-functions comprises at least one of which sub-functions are cascaded, which sub-functions are parallel, or a chronological relation between the K1 sub-functions.

In one embodiment, P1 sub-functions are a subset of the K1 sub-functions, where P1 is a positive integer less than K1 and greater than 1; any of the P1 sub-functions comprises at least one encoding layer.

In one subembodiment of the above embodiment, features of any two of the P1 sub-functions are the same; the features comprise a number of encoding layers, a size of input parameters and a size of output parameters for each encoding layer, and so on.

In one subembodiment of the above embodiment, there exists two of the P1 sub-function(s) having different features; the features comprise a number of encoding layers, a size of input parameters and a size of output parameters for each encoding layer, and so on.

In one embodiment, the first parameter group comprises at least one of the convolution kernel comprised in any encoding layer of the P1 sub-functions, or weights between different encoding layers in the P1 sub-functions.

In one embodiment, the features of the first function comprise: a value of the P1, a number of encoding layers comprised in any of P1 sub-functions, a size of input parameters and a size of output parameters for each encoding layer.

### Embodiment 7

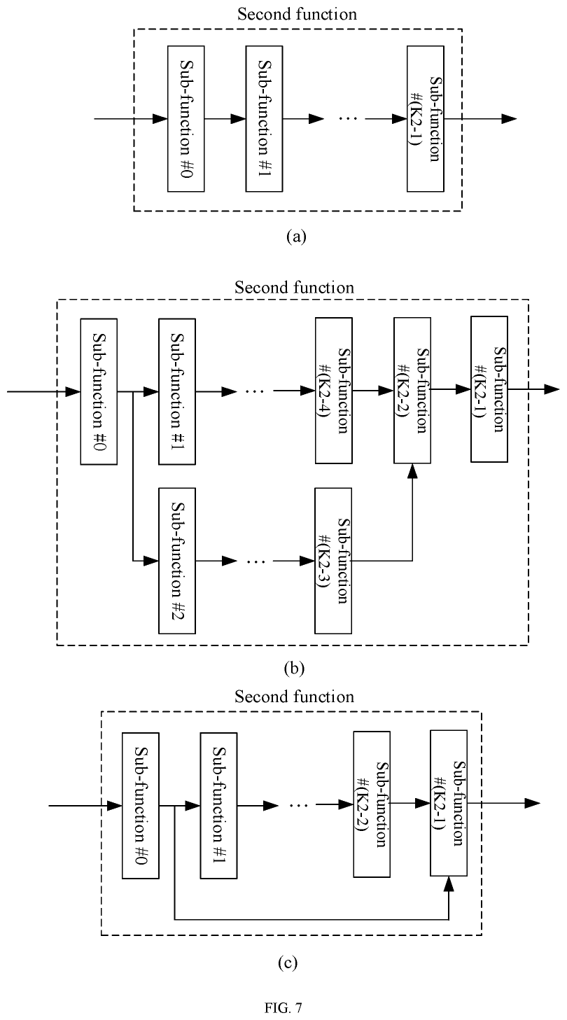

Embodiment 7 illustrates a schematic diagram of a second function according to one embodiment of the present application, as shown in FIG. 7. In embodiment 7, the first compressed CSI is used as input of the second function by the second node to generate a first CSI. The second function comprises K2 sub-functions, K2 being a positive integer greater than 1. In FIG. 7, the K2 sub-functions are respectively represented by sub-function #0, . . . , sub-function #(K2-1).

In one embodiment, the first CSI comprises a PMI.

In one embodiment, the first CSI comprises one or multiple of a CQI, a CRI or an RI.

In one embodiment, the first CSI comprises a channel matrix.

In one embodiment, the first CSI comprises amplitude and phase information of elements in a channel matrix.

In one embodiment, the first CSI comprises information of a channel matrix.

In one embodiment, the first compressed CSI comprises a second matrix, the first CSI comprises a third matrix, and a product of a number of rows and columns in the second matrix is less than a product of a number of rows and columns in the third matrix.

In one subembodiment of the above embodiment, the second matrix is a vector.

In one embodiment, the first compressed CSI consists of Q2 bits, the first CSI consists of Q3 bits, Q2 and Q3 being respectively positive integers greater than 1, Q3 being greater than the Q2.

In one embodiment, the second function is non-linear.

In one embodiment, an input of the second function comprises a compressed CSI, and an output of the second function comprises a resumed uncompressed CSI.

In one embodiment, a payload of any input of the second function is less than a payload of an output of the any input corresponding to the second function.

In one embodiment, a number of elements comprised in any input of the second function is less than a number of elements comprised in an output of the any input corresponding to the second function.

In one embodiment, the second function comprises a Neural Network.

In one embodiment, the second function comprises a neural network used for CSI compression.

In one embodiment, the second function comprises a decoder of a neural network used for CSI compression.

In one embodiment, the second function comprises a second parameter group, and the second parameter group comprises at least one parameter.

In one embodiment, the second parameter group comprises one or more of a convolution kernel, pooling function, parameters of pooling function, activation function, a threshold of activation function, or weights between feature maps.

In one embodiment, the first information indicates the second function.

In one embodiment, the first information indicates a value of at least partial parameters in the second parameter group.

In one embodiment, the first information block indicates at least partial features of the second function.

In one embodiment, the features of the second function comprise: one or more of the convolution kernel size, convolution layer, convolution step-size, pooling kernel size, pooling function, activation function, or number of feature maps.

In one embodiment, the K2 sub-functions comprise one or more of convolutional function, pooling function, cascading function, or activation function.

In one embodiment, the second parameter group comprises K2 parameter sub-groups, and the K2 parameter sub-groups are respectively used for the K2 sub-functions.

In one embodiment, there exists one of the K2 sub-functions comprising a pre-processing layer.

In one subembodiment of the above embodiment, sub-function #0 in FIG. 7 comprises a pre-processing layer.

In one subembodiment of the above embodiment, the pre-processing layer comprises a fully-connected layer.

In one subembodiment of the above embodiment, the pre-processing layer expands a size of an input of the second function.

In one embodiment, there exists one of the K2 sub-functions comprising a pooling layer.

In one embodiment, there exists at least one of the K2 sub-function(s) comprising at least one convolutional layer.

In one embodiment, there exists at least one of the K2 sub-function(s) comprising at least one decoding layer.

In one embodiment, the decoding layer comprises at least one convolutional layer.

In one embodiment, the decoding layer comprises at least one convolutional layer and one pooling layer.

In one embodiment, there exists one of the K2 sub-functions comprising a pre-processing layer, and there exists at least another one of the K2 sub-functions comprising at least one decoding layer.

In one embodiment, the second parameter group comprises at least one of a convolution kernel of any of the K2 sub-functions, or weights between different convolutional layers in the K2 sub-functions.

In one embodiment, there exists two of the K2 sub-functions being cascaded, that is, an input of one of the two sub-functions is an input of another one of the two sub-functions.

In one subembodiment of the above embodiment, sub-function #0 and sub-function #1 in FIG. 7(a) and FIG. 7(c) are cascaded.

In one embodiment, there exist two sub-functions in the K2 sub-functions being parallel; that is, an output of the two sub-functions are jointly used as an input to another sub-function in the K2 sub-functions, or an output of another sub-function in the K2 sub-functions is simultaneously used as an input to both two sub-functions.

In one subembodiment of the above embodiment, sub-function #1 and sub-function #2 in FIG. 7(b) are parallel.

In one subembodiment of the above embodiment, sub-function #(K2-3) and sub-function #(K2-4) in FIG. 7(b) are parallel.

In one embodiment, the feature of the second function comprise: at least one of a value of the K2, a number of sub-functions comprising the convolutional layer in the K2 sub-functions, a size of input parameters and a size of output parameters for each convolutional layer, or the relation between the K2 sub-functions comprising which sub-functions are cascaded and which sub-functions are parallel.

In one embodiment, P2 sub-functions is a subset of the K2 sub-functions, where P2 is a positive integer less than K2 and greater than 1; any of the P2 sub-functions comprises at least one decoding layer.

In one subembodiment of the above embodiment, features of any two sub-functions in the P2 sub-functions are the same; the features comprise a number of decoding layers, a size of input parameters and a size of output parameters for each decoding layer, and so on.

In one subembodiment of the above embodiment, there exists two of the P2 sub-functions having different features; the features comprise a number of decoding layers, a size of input parameters and a size of output parameters for each decoding layer, and so on.

In one embodiment, the second parameter group comprises at least one of the convolution kernel comprised in any decoding layer of the P2 sub-functions, or weights between different decoding layers in the P2 sub-functions.

In one embodiment, the features of the second function comprise: the value of P2, a number of decoding layers comprised in each one of P2 sub-functions, a size of input parameters and a size of output parameters for each decoding layer, and so on.

In one embodiment, the second node determines the second function according to the reception behavior in the first reference signal resource pool.

### Embodiment 8

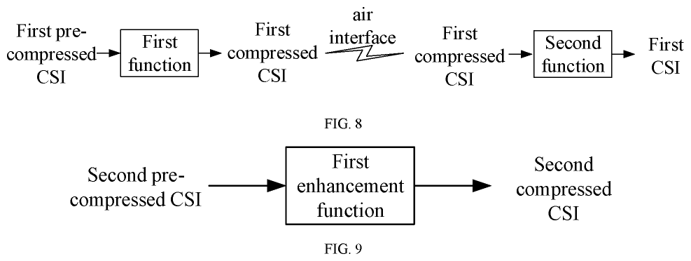

Embodiment 8 illustrates a schematic diagram of relations among a first pre-compressed CSI, a first compressed CSI, a first function and a second function according to one embodiment of the present application, as shown in FIG. 8. In embodiment 8, the first pre-compressed CSI is used by the first node as an input to the first function to generate the first compressed CSI; the first compressed CSI is used as an input of the second function by the second node to generate the first CSI.

In one embodiment, the first CSI comprises a resuming value of the first pre-compressed CSI.

In one embodiment, the first CSI comprises an estimation value of the first pre-compressed CSI.

In one embodiment, the first CSI comprises all or partial information of the first pre-compressed CSI.

In one embodiment, the first compressed CSI is carried by the third information block, the third information block is transmitted by the first node and received by the second node via an air interface.

In one embodiment, the first function is used to compress the first pre-compressed CSI to reduce the radio overhead of the first compressed CSI, and the second function is used to decompress the first compressed CSI to resume the first pre-compressed CSI as much as possible.

In one embodiment, the first node obtains a channel measurement for generating the first pre-compressed CSI based on a reference signal received in a first reference signal resource.

In one embodiment, the first reference signal resource comprises CSI-RS resources or SS/PBCH block resources.

In one embodiment, the first reference signal resource comprises a DMRS port.

In one embodiment, the second information block indicates that the target reference signal resource is associated with the first function, and the first reference signal resource is the target reference signal resource.

In one embodiment, the first reference signal resource and the target reference signal resource correspond to different reference signal resource identifiers.

In one embodiment, the reference signal resource identifier comprises an NZP-CSI-RS-ResourceSetId.

In one embodiment, the reference signal resource identifier comprises an SSB-Index.

In one embodiment, the first node obtains a first channel matrix based on a measurement for a reference signal received in the first reference signal resource, and any element in the first channel matrix comprises information of a channel over which a radio signal transmitted on an RS port of the first reference signal resource is conveyed on a frequency unit; the first channel matrix is used to generate the first pre-compressed CSI.

In one subembodiment of the above embodiment, the first pre-compressed CSI comprises amplitude and phase information of elements in the first channel matrix.

In one subembodiment of the above embodiment, the first pre-compressed CSI comprises the first channel matrix.

In one subembodiment of the above embodiment, the first pre-compressed CSI is obtained by mathematical transformation of the first channel matrix.

In one subembodiment of the above embodiment, the first CSI comprises amplitude and phase information of elements in the first channel matrix.

In one subembodiment of the above embodiment, the first CSI comprises an estimation value of the first channel matrix.

In one embodiment, the frequency unit is a subcarrier.

In one embodiment, the frequency unit is a Physical Resource Block (PRB).

In one embodiment, the frequency unit consists of multiple continuous subcarriers.

In one embodiment, the frequency unit consists of multiple continuous PRBs.

In one embodiment, the mathematical transformation comprises Discrete Fourier Transform (DFT).

In one embodiment, the mathematical transformation comprises one or more of quantization, transformation from spatial domain to angle domain, transformation from frequency domain to time domain, or truncation.

In one embodiment, the second function is an inverse function of the first function.

In one embodiment, the first function is established at the first node, and the second function is established at the second node.

In one embodiment, the first function is established at the first node and the second node at the same time, and the second function is established at the second node.

In one embodiment, the first function is established at the first node, and the second function is established at the first node and the second node at the same time.

In one embodiment, both the first function and the second function are established at the first node and the second node at the same time.

In one embodiment, encoders and decoders based on CsiNet or CRNet are respectively used to implement the first function and the second function.

In one subembodiment of the above embodiment, for a detailed description of CsiNet, refer to Chao-Kai Wen, Deep Learning for Massive CSI Feedback, 2018 IEEE Wireless Communications Letters, vol. 7 No. 5, Oct. 2018.

In one subembodiment of the above embodiment, for a detailed description of CRNet, refer to Zhilin Lu, Multi-resolution CSI Feedback with Deep Learning in Massive MIMO System, 2020 IEEE International Conference on Communications (ICC).

In one embodiment, the second node indicates the first function to the first node through the first information block.

In one embodiment, the second function is an inverse function of the first function, and the meaning of the phrase of the target reference signal resource being associated with the first function comprises: a compressed CSI generated based on a measurement for a reference signal received in the target reference signal resource is used as input to the second function.

In one embodiment, the second function is an inverse function of the first function, and the meaning of the phrase of the target reference signal resource being associated with the first function comprises: the second function is used to resume a CSI generated based on a measurement for a reference signal received in the target reference signal resource.

In one embodiment, the second function is an inverse function of the first function, and the meaning of the phrase of the target reference signal resource being associated with the first function comprises: the second function is used to resume information of a channel over which a reference signal received in the target reference signal resource is conveyed based on a compressed CSI generated from a measurement for a reference signal received in the target reference signal resource.

In one embodiment, the second function is an inverse function of the first function, and the meaning of the phrase of the target reference signal resource not being associated with the first function comprises: the second function is not used to resume information of a channel over which a reference signal received in the target reference signal resource is conveyed.

### Embodiment 9

Embodiment 9 illustrates a schematic diagram of a relation between a second pre-compressed CSI and a second compressed CSI according to one embodiment of the present application, as shown in FIG. 9. In embodiment 9, the second pre-compressed CSI is used as an input to the first enhancement function by the first node to generate the second compressed CSI.

In one embodiment, the second pre-compressed CSI comprises a PMI.

In one embodiment, the second pre-compressed CSI comprises one or multiple of a CQI, a CRI or an RI.

In one embodiment, the second pre-compressed CSI comprises amplitude and phase information of elements in a channel matrix.

In one embodiment, the second pre-compressed CSI comprises a matrix.

In one embodiment, the second pre-compressed CSI comprises a channel matrix.

In one embodiment, the second compressed CSI comprises a PMI.

In one embodiment, the second compressed CSI comprises one or multiple of a CQI, a CRI or an RI.

In one embodiment, the second compressed CSI comprises amplitude and phase information of elements in a channel matrix.

In one embodiment, the second compressed CSI comprises a matrix.

In one embodiment, the second compressed CSI comprises a vector.

In one embodiment, the second pre-compressed CSI comprises a fourth matrix, the second compressed CSI comprises a fifth matrix, a product of a number of rows and a number of columns in the fourth matrix is greater than a product of the number of rows and a number of columns in the fifth matrix.

In one subembodiment of the above embodiment, the fifth matrix is a vector.

In one embodiment, the second pre-compressed CSI consists of Q4 bits, and the second compressed CSI consists of Q5 bits, Q4 and Q5 are respectively positive integers greater than 1, Q4 being greater than Q5.

In one embodiment, the second information block indicates that the target reference signal resource is associated with the first enhancement function.

In one embodiment, the second information block indicates that the target reference signal resource is not associated with the first enhancement function.

In one embodiment, the second node determines the first enhancement function according to the reception behavior in the first reference signal resource pool.

In one embodiment, the second information block indicates that the target reference signal resource is associated with the first function but is not associated with the first enhancement function.

In one embodiment, the second information block indicates that the target reference signal resource is associated with the first function and is associated with the first enhancement function.

In one embodiment, the second information block indicates that the target reference signal resource is associated with the first enhancement function but is not associated with the first function.

In one embodiment, the second information block indicates that the target reference signal resource is not associated with the first function and the first enhancement function.

In one embodiment, if the target reference signal resource is associated with the first enhancement function, the target reference signal resource is associated with the first function.

In one embodiment, a measurement for the target reference signal resource is used to generate a target pre-compressed CSI; if the target reference signal resource is associated with both the first function and the first enhancement function, the target pre-compressed CSI is used as an input to the first enhancement function to generate a target compressed CSI; if the target reference signal resource is not associated with the first enhancement function but is associated with the first function, the target pre-compressed CSI is used as an input to the first function to generate a target compressed CSI.

### Embodiment 10

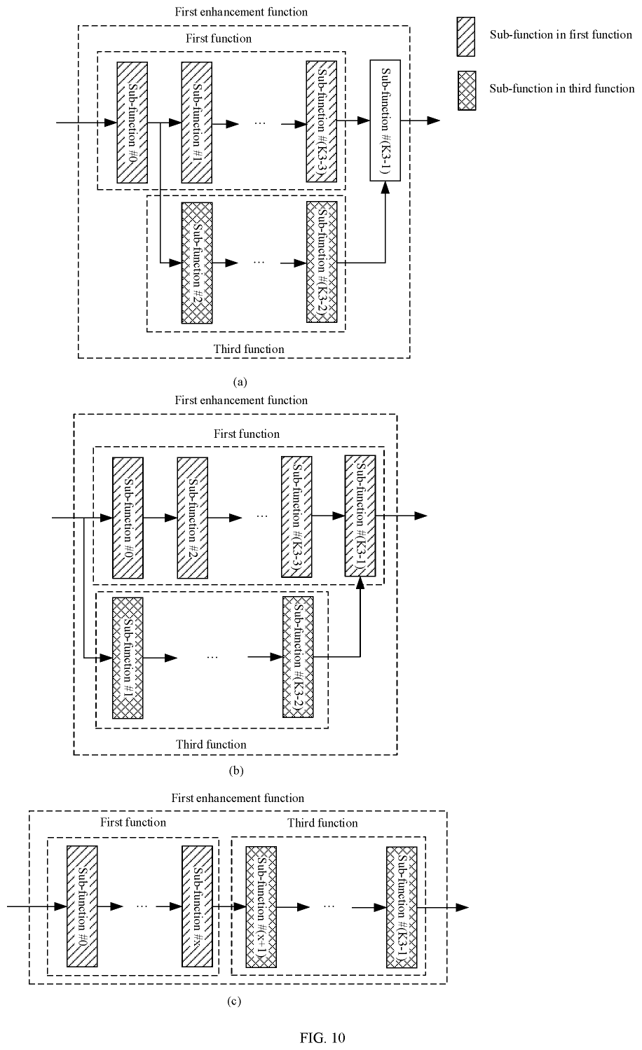

Embodiment 10 illustrates a schematic diagram of a first enhancement function according to one embodiment of the present application, as shown in FIG. 10. In embodiment 10, the first function and a third function are used to generate the first enhancement function.

In one embodiment, the first enhancement function is non-linear.

In one embodiment, an input of the first enhancement function comprises a result of channel measurement.

In one embodiment, an input of the first enhancement function comprises channel matrix.

In one embodiment, an input of the first enhancement function comprises an uncompressed CSI.

In one embodiment, an output of the first enhancement function comprises a compressed CSI.

In one embodiment, a payload of any input of the first enhancement function is greater than a payload of an output of the any input corresponding to the first enhancement function.

In one embodiment, a number of element(s) comprised in any input of the first enhancement function is greater than a number of element(s) comprised in an output of the any input corresponding to the first enhancement function.

In one embodiment, the first enhancement function comprises a neural network.

In one embodiment, the first enhancement function comprises a neural network used for CSI compression.

In one embodiment, the first enhancement function comprises an encoder for a neural network used for CSI compression.

In one embodiment, the first enhancement function comprises the first function.

In one embodiment, the first enhancement function comprises K3 sub-functions, K3 being a positive integer greater than 1; the K3 sub-functions comprise one or more of convolutional function, pooling function, cascading function, or activation function. In FIG. 10, the K3 sub-functions are respectively represented as sub-function #0, . . . , and sub-function #(K3-1). In FIG. 10, x is a positive integer less than the K3-1.

In one embodiment, the first function and the third function respectively consist of partial sub-functions of the K3 sub-functions.

In one embodiment, at least one of the K3 sub-functions comprises at least one encoding layer.

In one embodiment, a number of encoding layers comprised in the first enhancement function is greater than a number of encoding layers comprised in the first function.

In one embodiment, at least one sub-function not belonging to the first function among the K3 sub-functions comprises at least one encoding layer.

In one embodiment, an input to the first function is an input of the first enhancement function.

In one embodiment, the third function comprises one or more of convolution, pooling, cascading, or activation function.

In one embodiment, the first enhancement function is formed by cascading the first function and the third function.

In one embodiment, an output of the first function is an input of the third function, and an output of the third function is an output of the first enhancement function; as shown in FIG. 10(c).

In one embodiment, the first function and the third function are connected in parallel to generate the first enhancement function.

In one embodiment, the first function and the third function share a same input; as shown in FIG. 10(b).

In one embodiment, one sub-function in the first function and the third function share a same input; for example, sub-function #1 in FIG. 10(a) is a sub-function in the first function, and the sub-function #1 and the third function share a same input.

In one embodiment, an output of one sub-function in the first function is an input of the third function; for example, sub-function #0 in FIG. 10(a) is a sub-function of the first function, and an output of the sub-function #0 is an input of the third function.

In one embodiment, an output of a sub-function in the first function and an output of the third function are used together as an input of another sub-function in the first function; for example, both the sub-function #(K3-3) and sub-function #(K3-1) in FIG. 10(b) belong to the first function, and an output of the sub-function #(K3-3) and an output of the third function are used together as an input to the sub-function #(K3-1).

In one embodiment, an output of the first function is an output of the first enhancement function, as shown in FIG. 10(b).

In one embodiment, an output of the first function and an output of the third function are used together as an input to a fourth function, and an output of the fourth function is an output of the first enhancement function; for example, as shown in FIG. 10(a), the fourth function comprises sub-function #(K3-1) in FIG. 10(a).

In one embodiment, the meaning of the phrase of the target reference signal resource being associated with the first enhancement function is similar to the meaning of the phrase of the target reference signal resource being associated with the first function, except for replacing the first function with the first enhancement function.

In one embodiment, the first information block indicates the first enhancement function.

In one embodiment, the first information block indicates one or more of the convolution kernel, pooling function, pooling function parameters, activation function, threshold of activation function, weights between feature maps, convolution kernel comprised in each encoding layer, or weights between different encoding layers comprised in the first enhancement function.

In one embodiment, the first information block indicates features of the first enhancement function.

In one embodiment, the features of the first enhancement function comprise: one or more of a relation between the first function and the third function, the feature of the first function, or the feature of the third function.

In one subembodiment of the above embodiment, the features of the third function comprise: one or more of the convolution kernel size, convolution layer, convolution step-size, pooling kernel size, pooling function, activation function, or number of feature map.

In one subembodiment of the above embodiment, the relation between the first function and the third function comprises: at least one of which sub-functions in the first function and which sub-functions in the third function are cascaded, which are in parallel, or an order of sub-functions in the first function and sub-functions in the third function.

In one embodiment, the features of the first enhancement function comprise: at least one of a value of the K3, a number of sub-functions comprising encoding layers among the K3 sub-functions, a number of comprised encoding layers, or a size of input parameters and a size of output parameters for each encoding layer.

### Embodiment 11

Embodiment 11 illustrates a schematic diagram of a second enhancement function according to one embodiment of the present application, as shown in FIG. 11. In embodiment 11, the second compressed CSI is used as an input to the second enhancement function by the second node to generate a second CSI, and the second function and fifth function are used to generate the second enhancement function.

In one embodiment, the second CSI comprises a PMI.

In one embodiment, the second CSI comprises one or multiple of a CQI, a CRI or an RI.

In one embodiment, the second CSI comprises a channel matrix.

In one embodiment, the second CSI comprises amplitude and phase information of elements in a channel matrix.

In one embodiment, the second CSI comprises information of a channel matrix.

In one embodiment, the second CSI comprises a sixth matrix, the second compressed CSI comprises a fifth matrix, and a product of a number of rows and a number of columns of the fifth matrix is less than a product of a number of rows and a number of columns of the sixth matrix.

In one subembodiment of the above embodiment, the fifth matrix is a vector.

In one embodiment, the second CSI consists of Q6 bit groups, the second compressed CSI consists of Q5 bits, Q5 and Q6 are respectively positive integers greater than 1, and Q6 is greater than the Q5.

In one embodiment, the second enhancement function is non-linear.

In one embodiment, an input of the second enhancement function comprises a compressed CSI, and an output of the second enhancement function comprises a resumed pre-compressed CSI.

In one embodiment, a payload of any input of the second enhancement function is smaller than a payload of an output corresponding to any input of the second enhancement function.

In one embodiment, a number of elements comprised in any input of the second enhancement function is less than a number of elements comprised in an output of any input corresponding to the second enhancement function.

In one embodiment, the second enhancement function comprises a Neural Network.

In one embodiment, the second enhancement function comprises a neural network used for CSI compression.

In one embodiment, the second enhancement function comprises a decoder for a neural network used for CSI compression.

In one embodiment, the second enhancement function comprises the second function.

In one embodiment, the second enhancement function comprises K4 sub-functions, K4 being a positive integer greater than 1; the K4 sub-functions comprise one or more of convolutional function, pooling function, cascading function, or activation function. In FIG. 11, the K4 sub-functions are respectively represented as sub-function #0, . . . , and sub-function #(K4-1). In FIG. 11, x is positive integer less than the K4-1.

In one embodiment, the second function and the fifth function respectively consist of partial sub-functions in the K4 functions.

In one embodiment, at least one of the K4 sub-functions comprises at least one decoding layer.

In one embodiment, a number of decoding layers comprised in the second enhancement function is greater than a number of decoding layers comprised in the second function.

In one embodiment, at least one sub-function not belonging to the second function among the K4 sub-functions comprises at least one decoding layer.

In one embodiment, an input of the second function is an input of the second enhancement function.

In one embodiment, the fifth function comprises one or more of convolution, pooling, cascading, or activation function.

In one embodiment, the second enhancement function is formed by cascading the second function and the fifth function.

In one embodiment, an output of the second function is an input of the fifth function, and an output of the fifth function is an output of the second enhancement function, as shown in FIG. 11(c).

In one embodiment, the second function and the fifth function are connected in parallel to generate the second enhancement function.

In one embodiment, the second function and the fifth function share a same input, as shown in FIG. 11(b).

In one embodiment, one sub-function in the second function and the fifth function share a same input; for example, sub-function #1 in FIG. 11(a) is a sub-function in the second function, and the sub-function #1 shares a same input as the fifth function.

In one embodiment, an output of one sub-function in the second function is an input of the fifth function; for example, sub-function #0 in FIG. 11(a) is a sub-function in the second function, and the sub-function #0 is an input of the fifth function.

In one embodiment, an output of a sub-function in the second function and an output of the fifth function are used together as an input of another sub-function in the second sub-function; for example, the sub-function #(K4-3) and the sub-function #(K4-1) in FIG. 11(b) belong to the second function, and an output of the sub-function #(K4-3) and an output of the fifth function are used together as an input to the sub-function #(K4-1).

In one embodiment, an output of the second function is an output of the second enhancement function; as shown in FIG. 11(b).

In one embodiment, an output of the second function and an output of the fifth function are jointly used as an input to the sixth function, and an output of the sixth function is an output of the second enhancement function; for example, as shown in FIG. 11(a), the sixth function comprises sub-function #(K4-1) in FIG. 11(a).

In one embodiment, the second node determines the second enhancement function according to the reception behavior in the first reference signal resource pool.

In one embodiment, the second enhancement function is an inverse function of the first enhancement function; the meaning of the phrase of the target reference signal resource being associated with the first enhancement function is similar to the meaning of the phrase of the target reference signal resource being associated with the first function, except for replacing the first function with the first enhancement function, and the second function is replaced as the second enhancement function.

In one embodiment, the first information block indicates the second enhancement function.

In one embodiment, the first information block indicates one or more of the convolution kernel, pooling function, pooling function parameters, activation function, threshold of activation function, weights between feature maps, convolution kernel comprised in each decoding layer, or weights between different decoding layers comprised in the second enhancement function.

In one embodiment, the first information block indicates features of the second enhancement function.

In one embodiment, the features of the second enhancement function comprise: one or more of a relation between the second function and the fifth function, the features of the second function, or features of the fifth function.

In one subembodiment of the above embodiment, the features of the fifth function comprise: one or more of the convolution kernel size, convolution layer, convolution step-size, pooling kernel size, pooling function, activation function, or number of feature maps.

In one subembodiment of the above embodiment, the relation between the second function and the fifth function comprises: at least one of which sub-functions in the second function and which sub-functions in the fifth function are cascaded, which are parallel, or an order of sub-functions in the second function and sub-functions in the fifth function.

In one embodiment, the features of the second enhancement function comprise: at least one of a value of the K4, a number of sub-functions of decoding layer comprised in the K4 sub-functions, a number of comprised decoding layers, or a size of input parameters and a size of output parameters of each decoding layer.

### Embodiment 12

Embodiment 12 illustrates a schematic diagram of relations among a second pre-compressed CSI, a second compressed CSI, a first enhancement function and a second enhancement function according to one embodiment of the present application, as shown in FIG. 12. In embodiment 12, the second pre-compressed CSI is used as an input of the first enhancement function by the first node to generate the second compressed CSI, and the second compressed CSI is used as an input of the second enhancement function by the second node to generate the second CSI.

In one embodiment, the second CSI comprises an estimation value of the second pre-compressed CSI.

In one embodiment, the second CSI comprises all or partial information of the second pre-compressed CSI.

In one embodiment, the second compressed CSI is carried by the fourth information block, the fourth information block is transmitted by the first node and received by the second node via an air interface.

In one embodiment, the first enhancement function is used to compress the second pre-compressed CSI to reduce the radio overhead of the second compressed CSI, and the second enhancement function is used to decompress the second compressed CSI to resume the second pre-compressed CSI as much as possible.

In one embodiment, the second information block indicates that the target reference signal resource is associated with the first enhancement function, and the first node obtains a channel measurement used to generate the second pre-compressed CSI based on a reference signal received in the target reference signal resource.

In one embodiment, the second pre-compressed CSI is unrelated to a measurement for a reference signal received in the target reference signal resource.

In one embodiment, the second information block indicates that the target reference signal resource is not associated with the first enhancement function, and the second pre-compressed CSI is unrelated to a measurement for a reference signal received in the target reference signal resource.

In one embodiment, the second enhancement function is an inverse function of the first enhancement function.

In one embodiment, the first node obtains a channel measurement used to calculate the second pre-compressed CSI based on a reference signal received in a second reference signal resource.

In one embodiment, the second reference signal resources comprise CSI-RS resources or SS/PBCH Block resources.

In one embodiment, the second reference signal resource comprises a DMRS port.

In one embodiment, the second information block indicates that the target reference signal resource is associated with the first enhancement function, and the second reference signal resource is the target reference signal resource.

In one embodiment, the second reference signal resource and the target reference signal resource correspond to different reference signal resource identifiers.

In one embodiment, the second reference signal resource and the first reference signal resource correspond to different reference signal resource identifiers.

In one embodiment, the first node obtains a second channel matrix based on a channel measurement for a reference signal received in the second reference signal resource, and any element in the second channel matrix comprises information of a channel over which a radio signal transmitted on an RS port of the second reference signal resource is conveyed on a frequency unit; the second channel matrix is used to generate the second pre-compressed CSI.

In one subembodiment of the above embodiment, the second pre-compressed CSI comprises the second channel matrix.

In one subembodiment of the above embodiment, the second pre-compressed CSI comprises amplitude and phase information of elements in the second channel matrix.

In one subembodiment of the above embodiment, the second pre-compressed CSI is obtained by mathematically transforming the second channel matrix.

In one subembodiment of the above embodiment, the second CSI comprises amplitude and phase information of elements in the second channel matrix.

In one subembodiment of the above embodiment, the second CSI comprises an estimate value of the second channel matrix.

### Embodiment 13

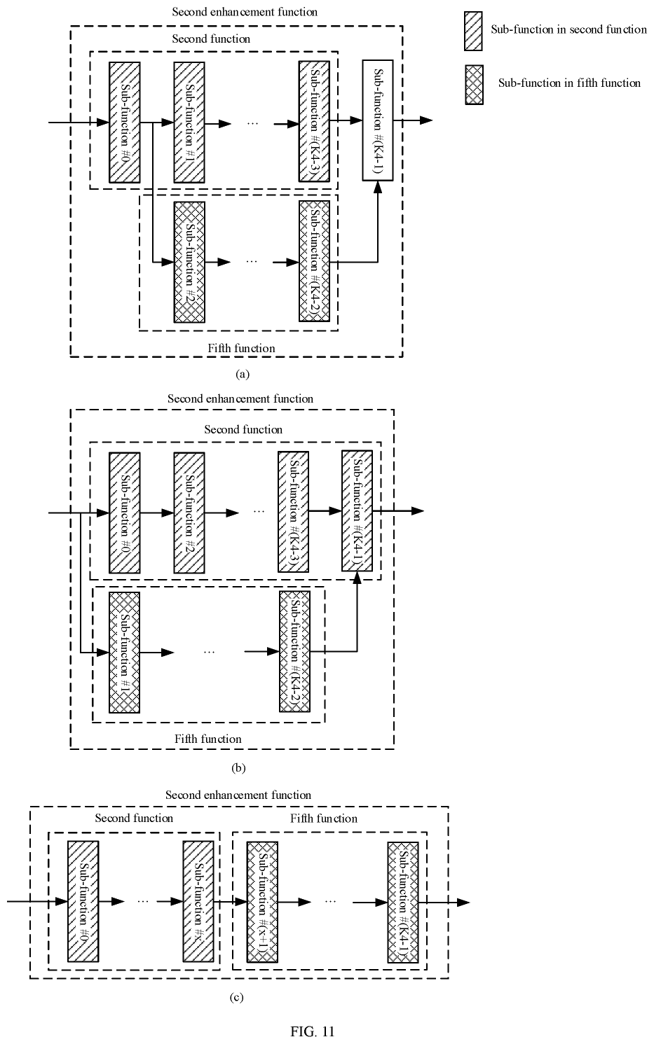

Embodiment 13 illustrates a schematic diagram of a second information block indicating a first enhancement function according to one embodiment of the present application, as shown in FIG. 13.

In one embodiment, the second information block indicates one or more of the convolution kernel, pooling function, pooling function parameters, activation function, threshold of activation function, weights between feature maps, convolution kernel comprised in each encoding layer, or weights between different encoding layers comprised in the first enhancement function.

In one embodiment, the second information block indicates features of the first enhancement function.

In one embodiment, the second information block indicates one or more of convolution kernel, pooling function, pooling function parameters, activation function, threshold of activation function, weights between feature maps, convolution kernel comprised in each decoding layer, or weights between different decoding layers comprised in the second enhancement function.

In one embodiment, the second information block indicates features of the second enhancement function.

### Embodiment 14

Embodiment 14 illustrates a schematic diagram of a reception behavior in a first reference signal resource pool being used by a target receiver of the first reference signal resource pool to determine a first function according to one embodiment of the present application, as shown in FIG. 14.

In one embodiment, the first reference signal resource pool comprises multiple reference signal resources.

In one embodiment, the first reference signal resource pool only comprises one reference signal resource.

In one embodiment, any reference signal resource in the first reference signal resource pool comprises an SRS resource.

In one embodiment, any reference signal resource in the first reference signal resource pool is an SRS resource.

In one embodiment, there exists one reference signal resource in the first reference signal resource pool comprising a DMRS port.

In one embodiment, there exists one reference signal resource in the first reference signal resource pool comprising a PTRS port.

In one embodiment, any reference signal resource in the first reference signal resource pool comprises at least one RS port.

In one subembodiment of the above embodiment, the RS port comprises an SRS port.

In one subembodiment of the above embodiment, the RS port comprises an antenna port.

In one subembodiment of the above embodiment, the RS port comprises a DMRS port or a PTRS port.

In one embodiment, reference signal resources in the first reference signal resource pool belong to a same carrier.

In one embodiment, reference signal resources in the first reference signal resource pool belong to a same BandWidth Part (BWP).

In one embodiment, reference signal resources in the first reference signal resource pool belong to a same serving cell.

In one embodiment, there exist two reference signal resources in the first reference signal resource pool belong to different carriers.

In one embodiment, there exist two reference signal resources in the first reference signal resource pool belong to different BWPs.

In one embodiment, there exist two reference signal resources in the first reference signal resource pool belong to different serving cells.

In one embodiment, there exists one reference signal resource in the first reference signal resource pool being aperiodic.

In one embodiment, there exists one reference signal resource in the first reference signal resource pool being semi-persistent.

In one embodiment, there exists one reference signal resource in the first reference signal resource pool being periodic.

In one embodiment, there exists a reference signal resource in the first reference signal resource pool whose one occurrence in time domain is earlier than one occurrence of the target reference signal resource in time domain.

In one embodiment, there exists a reference signal resource in the first reference signal resource pool whose one occurrence in time domain is later than one occurrence of the target reference signal resource in time domain.

In one embodiment, the meaning of the phrase of determining the first function comprises: determining a value of a parameter in the first parameter group.

In one embodiment, the meaning of the phrase of determining the first function comprises: determining features of the first function.

In one embodiment, a measurement for a reference signal received in the first reference signal resource pool is used by the second node to determine the first function.

In one embodiment, the second node obtains a channel measurement used to determine the first function based on a reference signal received in the first reference signal resource pool.

In one embodiment, the second node determines the first function based on a channel measurement for a reference signal received in the first reference signal resource pool.

In one embodiment, the second node determining a prioritization target of the first function comprises: optimizing an error between the first CSI and the first pre-compressed CSI.

In one embodiment, the prioritization comprises: minimizing.

In one embodiment, the prioritization comprises: making it not greater than a given threshold.

In one embodiment, the error comprises at least one of Mean Square Error (MSE), Linear Minimum MSE (LMNISE) or Normalized MSE (NMSE).

In one embodiment, the second node determines the first function and the second function together according to the reception behavior in the first reference signal resource pool.

In one embodiment, the first node determines the first enhancement function according to the reception behavior in the first reference signal resource pool.

In one embodiment, the first node determines the first enhancement function and the second enhancement function together according to the reception behavior in the first reference signal resource pool.

In one embodiment, the second node determines at least one of the second function, the first enhancement function and the second enhancement function based on a channel measurement for a reference signal received in the first reference signal resource pool.

### Embodiment 15

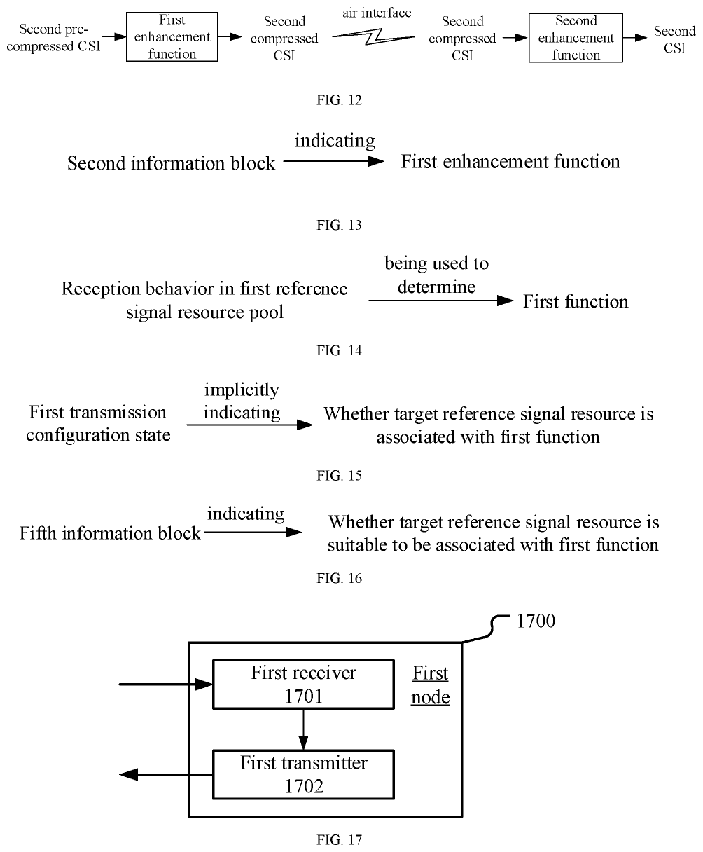

Embodiment 15 illustrates a schematic diagram of a first transmission configuration state implicitly indicating whether a target reference signal resource is associated with a first function according to one embodiment of the present application, as shown in FIG. 15.

In one embodiment, the second information block indicates the first transmission configuration state.

In one embodiment, the first transmission configuration state comprises a Transmission Configuration Indicator (TCI) state.

In one embodiment, the first transmission configuration state is a TCI state.

In one embodiment, the first transmission configuration state indicates a QCL relation.

In one embodiment, the first transmission configuration state comprises parameters for configuring a QCL relation between an RS port of the target reference signal resource and one or two reference signals.

In one embodiment, the first transmission configuration state is a TCI state, and the second information block indicates a TCI-StateId corresponding to the first transmission configuration state.

In one embodiment, the first transmission configuration state is a TCI state of the target reference signal resource.

In one embodiment, the second information block indicates that a TCI state of the target reference signal resource is the first transmission configuration state.

In one embodiment, the first transmission configuration state is used to determine a QCL relation of the target reference signal resource.

In one embodiment, the first transmission configuration state is used to determine spatial Rx parameters of the target reference signal resource.

In one embodiment, the first transmission configuration state is used to determine large-scale properties of a channel over which a reference signal received in the target reference signal resource is conveyed.

In one embodiment, the large-scale properties comprise one or more of delay spread, Doppler spread, Doppler shift, average delay, and the spatial Rx parameters.

In one embodiment, the first transmission configuration state indicates a third reference signal resource, and an RS port of the target reference signal resource and an RS port of the third reference signal resource are Quasi Co-Located.

In one subembodiment of the above embodiment, the third reference signal resources comprise CSI-RS resources or SS/PBCH Block resources.

In one subembodiment of the above embodiment, the first transmission configuration state indicates a QCL type corresponding to a third reference signal resource is QCL-Type D, and an RS port of the target reference signal resource and an RS port of the third reference signal resource are Quasi Co-Located corresponding to QCL-T eD.

In one subembodiment of the above embodiment, the first node can refer large-scale properties of a channel over which a reference signal in the target reference signal resources is conveyed from large-scale properties of a channel over which a reference signal in the third reference signal resource is conveyed.

In one subembodiment of the above embodiment, the first node can infer spatial reception parameters of a reference signal in the target reference signal resources from spatial reception parameters of a reference signal in the third reference signal resource.

In one embodiment, if the first transmission configuration state belongs to a first transmission configuration state set, and the target reference signal resource is associated with the first function; if the first transmission configuration state does not belong to the first transmission configuration state set, the target reference signal resource is not associated with the first function; the first transmission configuration state set comprises at least one transmission configuration state.

In one subembodiment of the above embodiment, the first transmission configuration state set is configured by an RRC signaling.

In one subembodiment of the above embodiment, any transmission configuration state in the first transmission configuration state set is a TCI state.

In one embodiment, if the third reference signal resource belongs to a first reference signal resource set, the target reference signal resource is associated with the first function; if the third reference signal resource does not belong to the first reference signal resource set, the target reference signal resource is not associated with the first function; the first reference signal resource set comprises at least one reference signal resource.

In one subembodiment of the above embodiment, the first reference signal resource set is configured by an RRC signaling.

In one embodiment, the first transmission configuration state implicitly indicates whether the target reference signal resource is associated with the first enhancement function.

### Embodiment 16

Embodiment 16 illustrates a schematic diagram of a fifth information block indicating whether a target reference signal resource is suitable to be associated with a first function according to one embodiment of the present application, as shown in FIG. 16.

In one embodiment, the fifth information block is carried by an RRC signaling.

In one embodiment, the fifth information block is carried by a MAC CE.

In one embodiment, the fifth information block is carried by a physical layer.

In one embodiment, the fifth information block comprises a CSI.

In one embodiment, the fifth information block comprises a CRI.

In one embodiment, the fifth information block is earlier than the first information block in time domain.

In one embodiment, the fifth information block is later than the first information block in time domain.

In one embodiment, the fifth information block is used by a transmitter of the second information block to determine whether the target reference signal resource is associated with the first function.

In one embodiment, the fifth information block indicates at least one reference signal resource suitable to be associated with the first function.

In one embodiment, the fifth information block indicates at least one reference signal resource not suitable to be associated with the first function.

In one embodiment, the fifth information block indicates at least one reference signal resource suitable for generating a compressed CSI.

In one embodiment, the fifth information block indicates at least one reference signal resource not suitable for generating a compressed CSI.

In one embodiment, a measurement for a reference signal received in the target reference signal resource is used to generate a target pre-compressed CSI, the target pre-compressed CSI is used as an input to the first function to generate a target compressed CSI, and the target compressed CSI is used as an input of the second function to generate a target CSI; the fifth information block indicates an error between the target CSI and target pre-compressed CSI.

In one subembodiment of the above embodiment, the fifth information block implicitly indicates whether the target reference signal resource is suitable to be associated with the first function by using the error.

In one subembodiment of the above embodiment, if the error is less than a first threshold, the target reference signal resource is suitable to be associated with the first function; if the error is greater than the first threshold, the target reference signal resource is not suitable to be associated with the first function.

In one subembodiment of the above embodiment, a transmitter of the second information block determines whether to indicate that the target reference signal resource is associated with the first function according to the error.

In one embodiment, the fifth information block indicates whether the target reference signal resource is suitable to be associated with the first enhancement function.

### Embodiment 17

Embodiment 17 illustrates a structure block diagram of a processor in a first node according to one embodiment of the present application, as shown in FIG. 17. In FIG. 17, a processor 1700 in the first node comprises a first receiver 1701 and a first transmitter 1702.

In Embodiment 17, the first receiver 1701 receives a first information block and a second information block; the first transmitter 1702 transmits a third information block.

In embodiment 17, the first information block indicates a first function, and the second information block indicates whether a target reference signal resource is associated with the first function; the third information block indicates a first compressed CSI, a first pre-compressed CSI is used as an input to the first function to generate the first compressed CSI.

In one embodiment, the first node is a UE; an input to the first function comprises an uncompressed CSI, and an output of the first function comprises a compressed CSI; the first pre-compressed CSI is used as an input to the first function by the first node to generate the first compressed CSI; the first pre-compressed CSI comprises a first matrix, the first compressed CSI comprises a second matrix, and a product of a number of rows and a number of columns of the second matrix is less than a product of a number of rows and a number of columns of the first matrix.

In one embodiment, the first transmitter 1702 transmits a fourth information block, the fourth information block indicates a second compressed CSI, and a second pre-compressed CSI is used as an input to a first enhancement function to generate the second compressed CSI; herein, the first function is used to generate the first enhancement function; the second information block indicates whether the target reference signal resource is associated with the first enhancement function.

In one embodiment, the second information block indicates the first enhancement function.

In one embodiment, the first transmitter 1702 transmits a reference signal in a first reference signal resource pool, and the first reference signal resource pool comprise at least one reference signal resource; herein, a reception behavior in the first reference signal resource pool is used by a target receiver of the first reference signal resource pool to determine the first function.

In one embodiment, the second information block comprises a first transmission configuration state, and the first transmission configuration state implicitly indicates whether the target reference signal resource is associated with the first function.

In one embodiment, the first transmitter 1702 transmits a fifth information block, and the fifth information indicates whether the target reference signal resource is suitable to be associated with the first function.

In one embodiment, the first receiver 1701 receives a reference signal in the target reference signal resource.

In one embodiment, the first node is a UE.

In one embodiment, the first node is a relay node.

In one embodiment, the first receiver 1701 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1702 comprises at least one of the antenna 452, the transmitter 454, the transmitting processor 468, the multi-antenna transmitting processor 457, the controller/processor 459, the memory 460, or the data source 467 in Embodiment 4.

### Embodiment 18

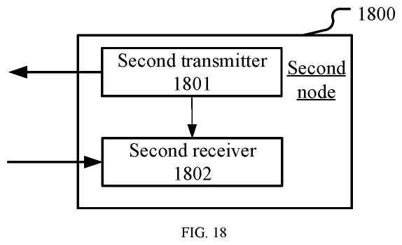

Embodiment 18 illustrates a structure block diagram of a processor in a second node according to one embodiment of the present application, as shown in FIG. 18. In FIG. 18, a processor 1800 in the second node comprises a second transmitter 1801 and a second receiver 1802.

In Embodiment 18, the second transmitter 1801 transmits a first information block and a second information block; the second receiver 1802 receives a third information block.

In embodiment 18, the first information block indicates a first function, and the second information block indicates whether a target reference signal resource is associated with the first function; the third information block indicates a first compressed CSI, a first pre-compressed CSI is used as an input to the first function to generate the first compressed CSI.

In one embodiment, the second node is a base station; an input to the first function comprises an uncompressed CSI, and an output of the first function comprises a compressed CSI; the first pre-compressed CSI is used as an input to the first function by a transmitter of the third information block to generate the first compressed CSI; the first pre-compressed CSI comprises a first matrix, the first compressed CSI comprises a second matrix, and a product of a number of rows and a number of columns of the second matrix is less than a product of a product of a number of rows and a number of columns of the first matrix.

In one embodiment, the second receiver 1802 receives a fourth information, the fourth information block indicates a second compressed CSI, a second pre-compressed CSI is used as an input to a first enhancement function to generate the second compressed CSI; herein, the first function is used to generate the first enhancement function; the second information block indicates whether the target reference signal resource is associated with the first enhancement function.

In one embodiment, the second information block indicates the first enhancement function.

In one embodiment, the second receiver 1802 receives a reference signal in a first reference signal resource pool, and the first reference signal resource pool comprise at least one reference signal resource; herein, the reception behavior in the first reference signal resource pool is used by the second node to determine the first function.

In one embodiment, the second information block comprises a first transmission configuration state, and the first transmission configuration state implicitly indicates whether the target reference signal resource is associated with the first function.

In one embodiment, the second receiver 1802 receives a fifth information block, and the fifth information indicates whether the target reference signal resource is suitable to be associated with the first function.

In one embodiment, the second transmitter 1801 transmits a reference signal in the target reference signal resource.

In one embodiment, a device in the second node is a base station.

In one embodiment, a device in the second node is a UE.

In one embodiment, a device in the second node is a relay node.

In one embodiment, the second transmitter 1801 comprises at least one of the antenna 420, the transmitter 418, the transmitting processor 416, the multi-antenna transmitting processor 471, the controller/processor 475, or the memory 476 in Embodiment 4.

In one embodiment, the second receiver 1802 comprises at least one of the antenna 420, the receiver 418, the receiving processor 470, the multi-antenna receiving processor 472, the controller/processor 475, or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block and a second information block, the first information block indicating a first function, the second information block indicating whether a target reference signal resource is associated with the first function; and
a first transmitter, transmitting a third information block, the third information block indicating a first compressed CSI, a first pre-compressed CSI being used as an input to the first function to generate the first compressed CSI.

2. The first node according to claim 1, wherein the first transmitter transmits a fourth information block, the fourth information block indicates a second compressed CSI, and a second pre-compressed CSI is used as an input to a first enhancement function to generate the second compressed CSI; wherein the first function is used to generate the first enhancement function; the second information block indicates whether the target reference signal resource is associated with the first enhancement function.

3. The first node according to claim 2, wherein the second information block indicates the first enhancement function.

4. The first node according to claim 1, wherein the first transmitter transmits a reference signal in a first reference signal resource pool, and the first reference signal resource pool comprise at least one reference signal resource;
wherein a reception behavior in the first reference signal resource pool is used by a target receiver of the first reference signal resource pool to determine the first function.

5. The first node according to claim 1, wherein the second information block comprises a first transmission configuration state, and the first transmission configuration state implicitly indicates whether the target reference signal resource is associated with the first function.

6. The first node according to claim 1, wherein the first transmitter transmits a fifth information block, and the fifth information indicates whether the target reference signal resource is suitable to be associated with the first function.

7. A second node for wireless communications, comprising:
a second transmitter, transmitting a first information block and a second information block, the first information block indicating a first function, the second information block indicating whether a target reference signal resource is associated with the first function; and
a second receiver, receiving a third information block, the third information block indicating a first compressed CSI, a first pre-compressed CSI being used as an input to the first function to generate the first compressed CSI.

8. The second node according to claim 7, wherein the second receiver receives a fourth information block, the fourth information block indicates a second compressed CSI, and a second pre-compressed CSI is used as an input to a first enhancement function to generate the second compressed CSI; wherein the first function is used to generate the first enhancement function; the second information block indicates whether the target reference signal resource is associated with the first enhancement function.

9. The second node according to claim 8, wherein the second information block indicates the first enhancement function.

10. The second node according to claim 7, wherein the second receiver receives a reference signal in a first reference signal resource pool, and the first reference signal resource pool comprises at least one reference signal resource;
wherein the reception behavior in the first reference signal resource pool is used by the second node to determine the first function.

11. The second node according to claim 7, wherein the second information block comprises a first transmission configuration state, and the first transmission configuration state implicitly indicates whether the target reference signal resource is associated with the first function.

12. The second node according to claim 7, wherein the second receiver receives a fifth information block, and the fifth information indicates whether the target reference signal resource is suitable to be associated with the first function.

13. A method in a first node for wireless communications, comprising:
receiving a first information block, the first information block indicating a first function;
receiving a second information block, the second information block indicating whether a target reference signal resource is associated with the first function; and
transmitting a third information block, the third information block indicating a first compressed CSI, a first pre-compressed CSI being used as an input to the first function to generate the first compressed CSI.

14. The method according to claim 13, comprising:
transmitting a fourth information, the fourth information block indicating a second compressed CSI, a second pre-compressed CSI being used as an input to a first enhancement function to generate the second compressed CSI;
wherein the first function is used to generate the first enhancement function; the second information block indicates whether the target reference signal resource is associated with the first enhancement function.

15. The method according to claim 14, wherein the second information block indicates the first enhancement function.

16. The method according to claim 13, comprising:
transmitting a reference signal in a first reference signal resource pool, the first reference signal resource pool comprising at least one reference signal resource;
wherein a reception behavior in the first reference signal resource pool is used by a target receiver of the first reference signal resource pool to determine the first function.

17. The method according to claim 13, wherein the second information block comprises a first transmission configuration state, and the first transmission configuration state implicitly indicates whether the target reference signal resource is associated with the first function.

18. The method according to claim 13, comprising:
transmitting a fifth information block, the fifth information indicating whether the target reference signal resource is suitable to be associated with the first function.
